(19) United States
(12) Patent Application Publication
(10) Pub. No.: US 2019/0372636 A1
(43) Pub. Date: Dec. 5, 2019

(54) RELAY APPARATUS AND RELAY METHOD

(71) Applicant: SoftBank Corp., Tokyo (JP)

(72) Inventors: Takanori TAKII, Tokyo (JP); Masahiko NANRI, Tokyo (JP); Takayuki YOSHIMURA, Tokyo (JP); Masanori NOMACHI, Tokyo (JP); Jumpei TAKAGI, Tokyo (JP)

(21) Appl. No.: 15/508,909

(22) PCT Filed: Dec. 14, 2016
(86) PCT No.: PCT/JP2016/087187

§ 371 Date: Mar. 3, 2017

(30) Foreign Application Priority Data
Oct. 20, 2016 (JP) 2016-205689

(51) Int. Cl. H04B 7/06; H04B 7/08; H04W 16/26; H04W 16/28

(52) U.S. Cl. CPC H04B 7/0608; H04W 16/28; H04W 16/26; H04B 7/0814

(57) ABSTRACT

A relay apparatus and relay method capable of enhancing communication quality in both transmission and reception when the relay apparatus relays communication between a terminal device and a macro cell base station are provided. A relay apparatus 20 for relaying communication between a terminal device 10 and a macro cell base station includes: an antenna group 25 constituted of a plurality of selectable antennas for receiving a signal from a macro cell base station; and an antenna selection unit 207 that selects a plurality of antennas from among the antenna group 25 to form a beam to transmit the signal to the macro cell base station on the basis of a reception status of the signal received from the macro cell station.

### TECHNICAL FIELD

The present invention relates to a relay apparatus and relay method for relaying communication between a terminal device(s) and a macro cell base station(s).

### BACKGROUND ART

It is conventionally known that a relay apparatus is interposed between a terminal device(s) and a macro cell base station(s) in order to secure a communication path between the terminal device(s) and the macro cell base station(s) within a building.

Regarding this, PTL 1 discloses a radio communication system including a relay apparatus that relays communication between a radio terminal(s) and a base station(s) and includes a plurality of antennas.

### CITATION LIST

### Patent Literature

PTL1: Japanese Patent Application Laid-Open (Kokai) Publication No. 2014-30186

### SUMMARY OF THE INVENTION

### Technical Problem

Regarding the radio communication system equipped with the above-described relay apparatus, the relay apparatus uses a predetermined reception antenna to receive a signal from among the plurality of antennas with respect to downlink which is a transmission link from the base station to the relay apparatus, and uses a predetermined transmission antenna to transmit the signal from among the plurality of antennas with respect to uplink which is a transmission link from the relay apparatus to the base station.

However, with such a radio communication system, if the reception antenna and the transmission antenna which are used to receive and transmit the signal between the relay apparatus and the base station are not appropriate, there is a possibility that specified communication quality may not be maintained. Accordingly, depending on the reception antenna and the transmission antenna which are used at the relay apparatus, there is fear that the specified communication quality of the signal between the relay apparatus and the base station may not be maintained and the communication quality including communication speeds and communication reliability of the entire communication system may degrade.

The present invention was devised in light of the above-described circumstances and it is an object of the invention to provide a relay apparatus and relay method capable of enhancing communication quality in both transmission and reception when a relay apparatus relays communication between a terminal device and a macro cell base station.

### Solution To Problem

As a result of ardent studies on selection of antennas to enhance the communication quality of the relay apparatus in light of the above-described object, the inventors of the present invention have focused attention on the fact that a combination of antennas for a relay apparatus which provides a preferred signal reception status in a specified frequency can also create a preferred signal transmission status in the signal transmission using the same frequency; and, therefore, they have come to think of the present invention.

A relay apparatus according to an aspect of the present invention is a relay apparatus for relaying communication between a terminal device and a macro cell base station, wherein the relay apparatus includes: an antenna group constituted of a plurality of selectable antennas for receiving a signal from a macro cell base station; and an antenna selection unit that selects a plurality of antennas from among the antenna group to form a beam to transmit a signal to the macro cell base station on the basis of a reception status of the signal received from the macro cell station.

With the above-described relay apparatus, the antenna selection unit may prioritize selection of an antenna, whose reception intensity of the signal from the macro cell base station is high, from among the antenna group.

A relay method according to an aspect of the present invention is a relay method for relaying communication between a terminal device and a macro cell base station, wherein the relay method includes the steps of: having an antenna group constituted of a plurality of selectable antennas receive a signal from a macro cell base station; and selecting a plurality of antennas from among the antenna group to form a beam to transmit a signal to the macro cell base station on the basis of a reception status of the signal received from the macro cell station.

### Advantageous Effects of the Invention

According to the present invention, communication quality in both transmission and reception can be enhanced when a relay apparatus relays communication between a terminal device and a macro cell base station.

### BRIEF DESCRIPTION OF DRAWINGS

FIG. 1 is a configuration diagram of a mobile communications system according to an embodiment;

FIG. 2 is a configuration diagram of a relay apparatus according to an embodiment;

FIG. 3 is a sequence diagram for explaining a procedure for antenna selection processing according to an embodiment; and

FIG. 4 is a conceptual diagram for explaining the antenna selection processing according to an embodiment.

### DESCRIPTION OF EMBODIMENTS

An embodiment of the present invention will be explained below with reference to the attached drawings. However, the embodiment explained below will be given merely for the purpose of illustration and there is no intention to exclude application of various variations or techniques which are not clearly specified below. In other words, the present invention can be implemented with various modifications without the scope departing from the gist of the invention. Furthermore, the same or similar reference numerals are assigned to, and represent, the same or similar elements in the illustrations in the series of drawings.

[Configuration of Mobile Communications System]

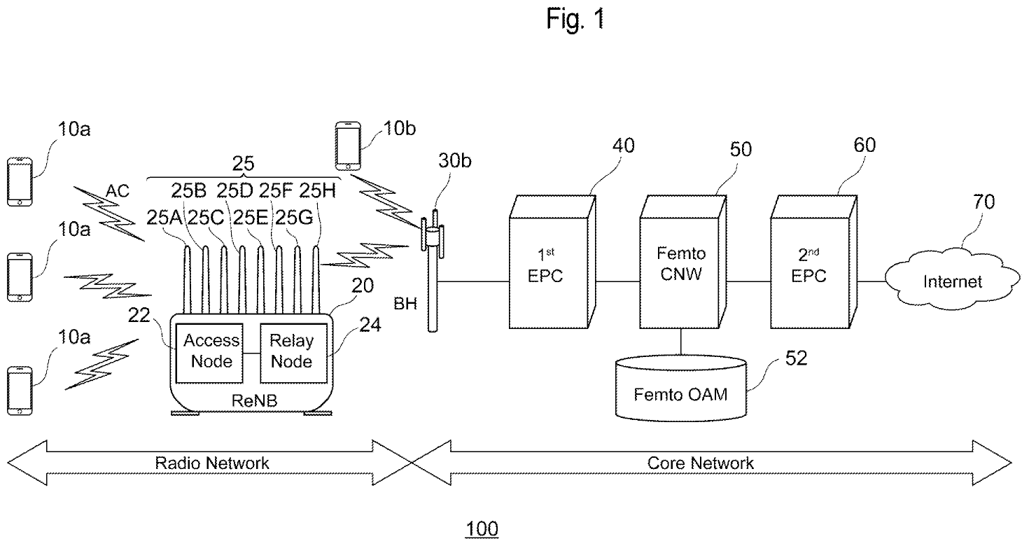

FIG. 1 is a configuration diagram of a mobile communications system including a femto cell base station (relay apparatus) according to an embodiment. A mobile communications system 100 according to this embodiment is illustratively a mobile communications system according to the LTE (Long Term Evolution) system whose standards are set in conformity with 3GPP and includes a radio network and a core network. The configuration of the radio network and the configuration of the core network will be explained sequentially below.

(Configuration of Radio Network)

Referring to FIG. 1, the mobile communications system 100 includes terminal devices 10, a relay apparatus 20, and a donor base station (macro cell base station) 30 as the configuration of the radio network. Incidentally, the radio network is called E-UTRAN (Evolved Universal Terrestrial Radio Access Network) according to the LTE system.

The terminal device 10 is a device that communicates with the relay apparatus 20 or the donor base station 30. The terminal device 10 is a mobile portable communication terminal such as a smartphone or a cell phone and is also called UE (User Equipment). FIG. 1 illustrates: terminal devices 10a that exist in a service area of a cell (the range capable of communication) formed by the relay apparatus 20 and are connected to the relay apparatus 20; and a terminal device 10b that exists in a service area of a cell formed by the donor base station 30 and is connected to the terminal device 10b. The terminal devices 10a and the terminal device 10b will be hereinafter sometimes collectively referred to as the terminal device 10.

The relay apparatus 20 can be moved and is an apparatus for relaying communication between the terminal devices 10a and the donor base station 30. The relay apparatus 20 is also called a ReNB (Repeater type eNodeB) and constitutes one node in the radio network.

The relay apparatus 20 is configured by including an access node 22 and a relay node 24.

The access node 22 establishes radio communication with the terminal devices 10a and provides the terminal devices 10a with packet communication services (such as voice packet communication services and multimedia services). The access node 22 is also called a femto base station. Radio communication between the access node 22 and the terminal devices 10a is also called an access link (AC: Access Link). The cell formed by the access node 22 and its cell size is of a smaller scale than that of the donor base station 30 and constructs a communication area with a radius ranging from several meters to tens of meters.

The access node 22 establishes radio communication with the donor base station 30 via the relay node 24. The relay node 24 is also called CPE (Customer Premises Equipment). Radio communication between the relay node 24 and the donor base station 30 is also called backhaul (BH: Backhaul).

Incidentally, the access node 22 and the relay node 24 may be configured as separate nodes. When they are configured as the separate nodes, the relay node 24 serves the role of the relay apparatus according to the present invention.

The relay apparatus 20 includes an antenna group 25 constituted of a plurality of selectable antennas 25A to 25H used when relaying communication between the terminal devices 10a and the donor base station 30. For example, the relay apparatus 20 includes eight antennas 25A to 25H and transmits and receives a signal while changing a combination of the eight antennas 25A to 25H. Specifically speaking, the relay apparatus 20 is configured so that when the relay apparatus 20 selects the antennas 25A, 25C, 25D, 25G from the antenna group 25 on the basis of the signal reception status of each antenna 25A to 25H, it also uses the antennas 25A, 25C, 25D, 25G to transmit the signal. Incidentally, it is only necessary to set a plural number of antennas to be included in the antenna group 25 and there is no limitation on that number.

The donor base station 30 establishes radio communication with the access node 22 via the relay node 24. The donor base station 30 is also called a Donor eNB (Donor eNode B). The donor base station 30 constructs a communication area with a radius ranging from hundreds of meters to tens of kilometers.

(Configuration of Core Network)

Referring to FIG. 1, the mobile communications system 100 includes a first core network EPC (Evolved Packet Core) 40, a femto core network 50 (communication control server), and a second core network EPC 60 as the configuration of the core network. Incidentally, this embodiment is explained as including the first core network EPC 40 and the second core network EPC 60; however, the core network may be configured from one core network EPC.

The first core network EPC 40 is connected to, for example, the donor base station 30 and has a function that manages movements of, and certifies, the individual terminal devices 10 via the donor base station 30, and manages processing for setting packet communication data paths, and a function that performs quality control of the radio network.

The femto core network 50 is a network for performing various kinds of management regarding the relay apparatus 20. The femto core network 50 is connected to, for example, a femto OAM (Femto Operations Administration Maintenance) 52 and has a function that operates, manages, and maintains the relay apparatus 20.

The second core network EPC 60 has, for example: a function that controls call connections to provide mobile communication services or controls the services; a function that serves as a switching station to receive calls from external networks such as the Internet 70 to contract subscribers in the radio network or subscribers who are roaming in the radio network; a function that manages movements of, and certifies, the individual terminal devices 10 in the second core network EPC 60 and manages processing for setting packet communication data paths; and a function that performs communication policy control such as quality control and performs control pursuant to billing rules.

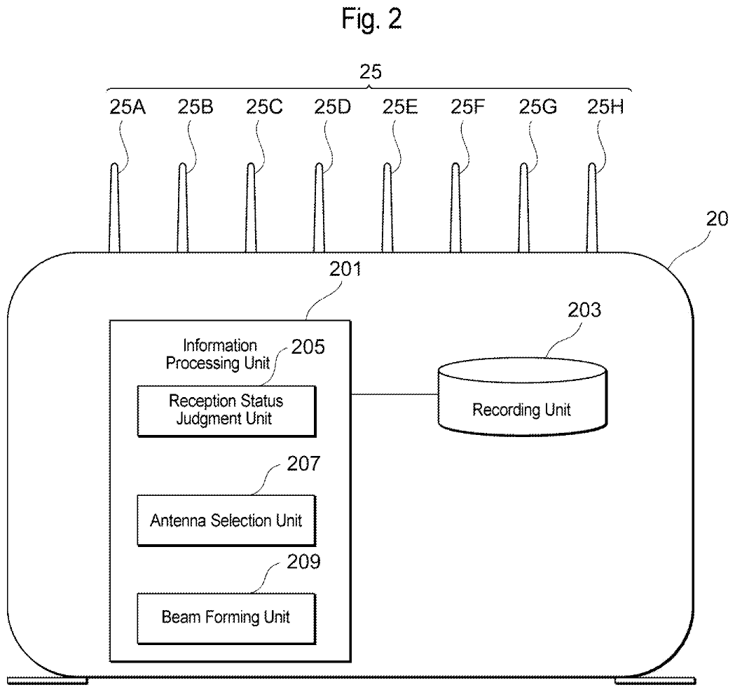

FIG. 2 is a configuration diagram of a relay apparatus according to an embodiment. Referring to FIG. 2, the relay apparatus 20 illustratively includes: an information processing unit 201 that executes information processing for relaying communication between the terminal devices 10a and the donor base station 30; and a recording unit 203 that records reception signal levels described later and antennas selected by an antenna selection unit 204 described later by associating the selected antennas with the reception signal levels. The information processing unit 201 functionally includes a reception status judgment unit 205, an antenna selection unit 207, and a beam forming unit 209.

The reception status judgment unit 205 judges the reception status of a signal which the antennas 25A to 25H receive from the donor base station 30. For example, the reception status judgment unit 205 judges the reception status of the signal on the basis of a specified physical quantity, for example, whether the reception signal level (reception intensity) is high or low. Specifically speaking, reference is made to at least one of RSRP (Reference Signal Received Power) and RSSI (Received Signal Strength Indicator) as the reception signal level.

The RSRP is a basic parameter for evaluating the reception signal level of radio waves from the donor base station and is an index whose level changes considerably depending on the selected combination of antennas 25A to 25H. This is because directivity regarding transmission and reception of electromagnetic waves changes considerably depending on the selected combination of antennas 25A to 25H. The RSRP is determined on the basis of other factors, that is, transmission power of the donor base station, installment conditions of the base station including orientations and heights of the antennas 25A to 25H for the donor base station, and measurement environment including the distance from the donor base station and whether any obstacle(s) exists or not. The RSSI is, like the RSRP, a basic parameter for evaluating the reception signal level of radio waves from the donor base station. However, unlike the RSRP, the RSSI is a parameter that can change depending on not only the installment conditions and measurement environment of the donor base station, but also a traffic amount of the measurement target base station and its surrounding base stations.

The reception status judgment unit 205 may judge the reception status of the signal by further referring to at least one of RSRQ (Reference Signal Received Quality) and SINR (Signal to Interference plus Noise power Ratio) as a physical quantity to judge the reception status.

The RSRQ is one of indexes representing reception quality of radio waves from the donor base station and is a parameter calculated based on a ratio of RSRP to RSSI. The SINR is a parameter representing a ratio of received signal power to interference and noise power in consideration of interference from surrounding donor base stations and other relay apparatuses.

The antenna selection unit 207 selects a plurality of antennas, which form a beam to transmit a signal to the donor base station 30 on the basis of the reception status of the signal received from that donor base station 30, from the antenna group 25. For example, the antenna selection unit 207 selects a plurality of antennas, whose reception signal level of the signal to be received from the donor base station 30 is high, from the antenna group 25. According to recognition by the inventors of the present invention, the combination of antennas thus selected to realize a preferred reception status provides a preferred transmission status also upon transmission of electromagnetic waves of the same frequency.

The beam forming unit 209 forms the beam to transmit the signal to the donor base station 30 by using the plurality of antennas selected from the antenna group 25.

[Antenna Selection Processing]

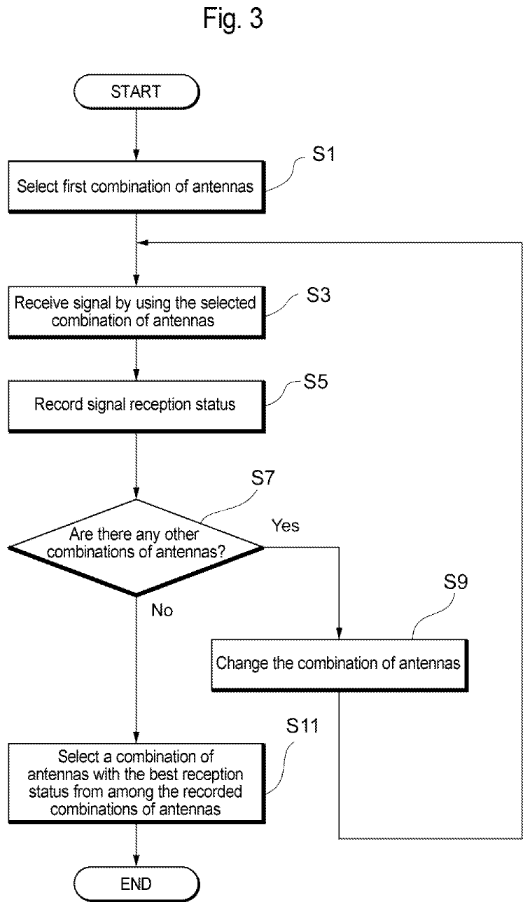

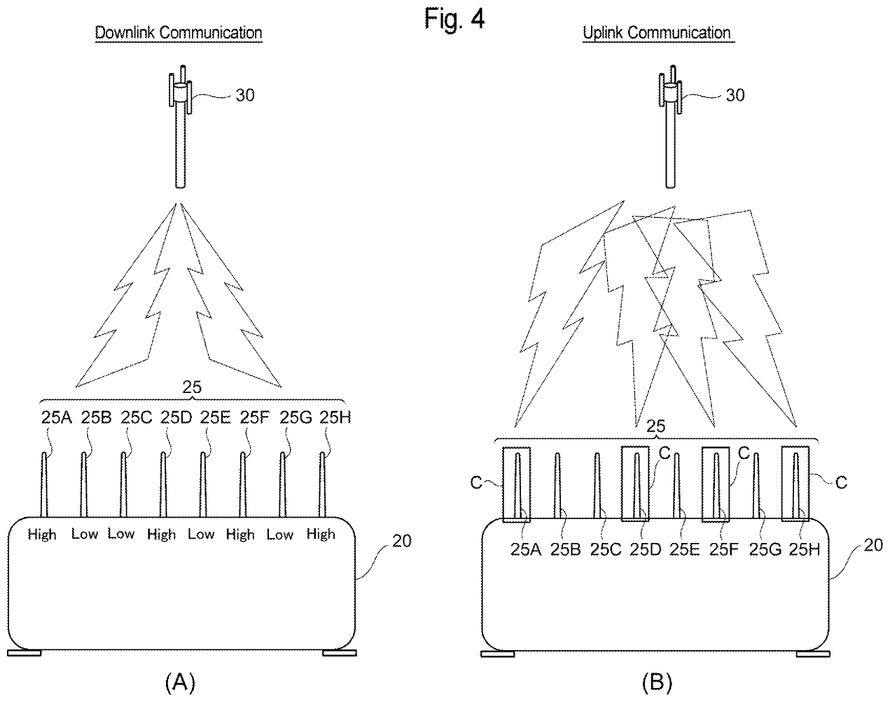

Antenna selection processing of the relay apparatus according to an embodiment will be explained with reference to FIG. 3 and FIG. 4. FIG. 3 is a sequence diagram for explaining a procedure for the antenna selection processing of the relay apparatus according to an embodiment. FIG. 4 is a schematic diagram for explaining the antenna selection processing of the relay apparatus according to an embodiment. FIG. 4A is a diagram illustrating downlink communication indicative of transmission of a signal from the donor base station 30 to the relay apparatus 20, and FIG. 4B is a diagram illustrating uplink communication indicative of transmission of a signal from the relay apparatus 20 to the donor base station 30.

As a premise for that antenna selection processing flow, a user of the mobile communications system, for example, downloads antenna selection processing application software according to an embodiment from a specified site on the network and saves the antenna selection processing application software in the relay apparatus 20 so that it can be executed. Then, when the user issues an instruction to execute the antenna selection processing application software, a program operation based on the antenna selection processing application software is started.

(Step S1 in FIG. 3)

Referring to FIG. 4A, the relay apparatus 20 has the antenna group 25, which is constituted of a plurality of selectable antennas 25A to 25H, receives a signal from the donor base station 30 (macro cell base station). All the antennas 25A to 25H can operate as reception antennas. The antenna selection unit 207 illustrated in FIG. 2 selects a first combination of antennas to receive the signal from the donor base station 30.

(Step S3)

The relay apparatus 20 receives the signal from the donor base station 30 by using the first combination of antennas selected by the antenna selection unit 207.

The reception status judgment unit 205 illustrated in FIG. 2 judges the reception status of the signal which the first combination of antennas selected by the antenna selection unit 207 has received from the donor base station 30. For example, the reception status judgment unit 205 judges the reception signal level (reception intensity) of each of the first combination of antennas. The reception status judgment unit 205 judges whether the reception signal level of each of the first combination of antennas is high or low, by comparing the reception signal levels of the first combination of antennas with each other.

(Step S5)

The recording unit 203 illustrated in FIG. 2 records the reception status of the signal when the first combination of antennas selected by the antenna selection unit 207 receives the signal, with respect to each combination of antennas. Incidentally, the recording unit 203 may be configured to record the reception status of the signal upon receiving the signal with respect to each antenna.

(Step S7)

The antenna selection unit 207 judges whether there are any other combinations of antennas. When the antenna selection unit 207 determines that there are other combinations of antennas (when Yes), the processing proceeds to step S9. When the antenna selection unit 207 determines that there are no other combinations of antennas (when No), the processing proceeds to step S11.

(Step S9)

When the antenna selection unit 207 determines that there are other combinations of antennas (when Yes in step S7), it changes the first combination of antennas selected in step S1. Then, the processing returns to step S3 and the same processing as described above is executed. Specifically speaking, in step S3, the relay apparatus 20 receives the signal from the donor base station 30 by using another combination of antennas changed by the antenna selection unit 207. The reception status judgment unit 205 judges the reception status of the signal which the other changed combination of antennas has received from the donor base station 30. In step S5, the recording unit 203 records the reception status of the signal when the other combinations of antennas changed by the antenna selection unit 207 have received the signal with respect to each of the other combinations of antennas.

In this way, the antenna selection unit 207 repeats selecting a combination of antennas; the reception status judgment unit 205 judges the reception status with respect to each selected or changed combination of antennas; and the recording unit 203 records the reception status of the selected or changed combinations of antennas with respect to each of the selected or changed combinations of antennas.

(Step S11)

When the antenna selection unit 207 judges that there are no other combinations of antennas (when No in step S7), it selects a combination of antennas with the best reception status from among the antenna group 25 on the basis of the reception status with respect to each of the combinations of antennas recorded in the recording unit 203. For example, as indicated in FIG. 4A and with rectangular frames C in FIG. 4B, the antenna selection unit 207 prioritizes selection of the antennas 25A, 25D, 25F, 25H, whose reception signal level (reception intensity) of the signal from the donor base station 30 is high, from among the antenna group 25.

The antenna selection unit 207 may select at least two or more of the antennas 25A, 25D, 25F, 25H, whose reception signal level of the signal from the donor base station 30 is high, from among the antenna group 25 in order to form the beam to transmit the signal to the donor base station 30, and does not necessarily have to select all the antennas 25A, 25D, 25F, 25H.

The beam forming unit 209 illustrated in FIG. 2 forms the beam to transmit the signal to the donor base station 30 by using the plurality of selected antennas 25A, 25D, 25F, 25H as indicated with the rectangular frames C in FIG. 4B. The beam forming unit 209 forms the beam by performing weighting with respect to each of the plurality of selected transmission antennas 25A, 25D, 25F, 25H.

For example, according to the LTE TDD (Time Division Duplex) system, the same frequency is used for downlink indicative of transmission of a signal from the donor base station 30 to the relay apparatus 20 and uplink indicative of transmission of the signal from the relay apparatus 20 to the donor base station 30. So, the plurality of antennas for forming the optimal beam for the uplink can be selected and the weight of each of the plurality of antennas can be estimated by judging the reception signal level during the downlink communication.

[Advantageous Effects]

According to an embodiment as described above, a plurality of antennas for forming the beam to transmit the signal to the donor base station 30 are selected from among the antenna group 25 on the basis of the reception status of the signal received from the donor base station 30. So, when the relay apparatus 20 relays communication between the terminal devices 10a and the donor base station 30, optimal antennas are selected to transmit and receive the signal between the relay apparatus 20 and the donor base station 30, so that the transmission and reception of the signal can be implemented smoothly. Therefore, the communication quality can be enhanced for both the transmission and the reception.

[Other Embodiments]

The present invention has been described by referring to the embodiment as described above; however, the description and drawings which constitute part of this disclosure should not be understood to limit this invention. Various substitute embodiments, examples, and techniques to be operated will be made clear for those skilled in the art on the basis of this disclosure.

### INDUSTRIAL APPLICABILITY

The aforementioned embodiment has described an example of a mobile communications system according to the LTE standard which is the telecommunications standard for mobile communications; however, the invention is not limited to this example and the present invention can be also applied to other telecommunications standards and any telecommunications standards to be established in future. Specifically speaking, the present invention can be applied as long as it is a system in which there is fear of: incapacity to maintain specified communication quality of a signal between a relay apparatus and a donor base station depending on reception antennas and transmission antennas used for the relay apparatus; and degradation of the communication quality including communication speeds and communication reliability of the entire communication system. When the relay apparatus relays communication between a terminal device and the donor base station by applying the relay method according to the present invention, the operation and effect capable of enhancing the communication quality for both the transmission and reception can be expected.

### REFERENCE SIGNS LIST

10 terminal device
20 relay apparatus
22 access node
24 relay node
25 antennas
30 donor base station (macro cell base station)
40 first core network EPC
50 femto core network
60 second core network EPC
100 mobile communications system
201 information processing unit
203 recording unit
205 reception status judgment unit
207 antenna selection unit
209 beam forming unit

1. A relay apparatus for relaying communication between a terminal device and a macro cell base station,
the relay apparatus comprising:
an antenna group constituted of a plurality of selectable antennas for receiving a signal from a macro cell base station; and
an antenna selection unit that selects a plurality of antennas from among the antenna group to form a beam to transmit a signal to the macro cell base station on the basis of a reception status of the signal received from the macro cell station.

2. The relay apparatus according to claim 1, wherein the antenna selection unit prioritizes selection of an antenna, whose reception intensity of the signal from the macro cell base station is high, from among the antenna group.

3. A relay method for relaying communication between a terminal device and a macro cell base station, the relay method comprising the steps of:
having an antenna group constituted of a plurality of selectable antennas receive a signal from a macro cell base station; and
selecting a plurality of antennas from among the antenna group to form a beam to transmit a signal to the macro cell base station on the basis of a reception status of the signal received from the macro cell station.
